(19) United States
(12) Patent Application Publication
(10) Pub. No.: US 2007/0023243 A1
(43) Pub. Date: Feb. 1, 2007

(54) Combined pneumatic cylinder and corresponding control method

(75) Inventors: Johann Baumgartner, Moosburg (DE); Alf Siebke, Schondorf (DE)

Correspondence Address: CROWELL & MORING LLP;INTELLECTUAL PROPERTY GROUP, P.O. BOX 14300, WASHINGTON, DC, 20044-4300, US

(73) Assignee: Knorr-Bremse Systeme Fuer Nutzfahrzeuge GmbH, Muenchen (DE)

(21) Appl. No.: 11/473,111

(22) Filed: Jun. 23, 2006

Related U.S. Application Data
(63) Continuation of application No. PCT/EP04/14476, filed on Dec. 20, 2004.

(30) Foreign Application Priority Data
Dec. 23, 2003 (DE) 103 60 879.6

(51) Int. Cl. F16F 9/12

(52) U.S. Cl. 188/266

(57) ABSTRACT

A combined pneumatic cylinder and a corresponding control method are characterized in that a spring for realizing the parking brake function is directly placed inside one of two pressure chambers and, to be precise, inside the pressure chamber that is designed for effecting service brakings by increasing pressure. The service brake function as well as the parking brake function can be realized by means of only two pressure chambers and the spring.

### CROSS REFERENCE TO RELATED APPLICATIONS

This application is a continuation of PCT International Application No. PCT/EP2004/014476, filed on Dec. 20, 2004, which claims priority under 35 U.S.C. § 119 to German Patent Application No. 103 60 879.6, filed Dec. 23, 2003, the entire disclosures of which are herein expressly incorporated by reference.

### BACKGROUND AND SUMMARY OF THE INVENTION

The invention relates to a combined pneumatic cylinder for a vehicle brake and to a method for controlling a combined pneumatic cylinder of this type.

Different designs of combined pneumatic cylinders are known. They generate the braking forces for the service brake, the parking brake and, in general, also for the auxiliary brake function of the vehicle. Combined pneumatic cylinders for pneumatically actuated disc brakes often have a service brake cylinder section (for example, a diaphragm cylinder) which is attached to the parking brake cylinder section, in which the helical spring is arranged for actuating the piston of the parking brake cylinder. They are, therefore, often of relatively large design and are relatively expensive.

The invention has the object of eliminating these disadvantages of the prior art.

The invention achieves this object with regard to the combined pneumatic cylinder by providing a brake cylinder housing, in which a piston which is arranged on a piston rod is guided displaceably. The brake cylinder housing is divided by the piston into two pressure spaces, which each have a compressed air connection. Furthermore, one end of the piston rod penetrates the brake cylinder housing to the outside, and a spring for realizing the parking brake function also is arranged directly in one of the two pressure spaces, which is designed for carrying out service brake operations by way of a pressure increase. The result is that both the service brake function and the parking brake function can be realized with only two pressure spaces and the spring. With regard to the method for controlling a combined pneumatic cylinder of this type, in parking brake operations, the pressure in the first pressure space without a spring is reduced, with the result that the spring is relieved and the piston rod extends, and in service brake operations, the piston rod extends as a result of ventilation of the second pressure space, a force counteracting the braking force of the spring in the event of service brake operations by way of a minimum pressure (Pmin) being maintained in the first pressure space, in particular in such a way that the braking force of the spring is compensated for.

Advantageous refinements are described and claimed herein.

In accordance with the present invention, a combined pneumatic cylinder for a vehicle brake is provided which has the following features: a brake cylinder housing, in which a piston which is arranged on a piston rod is guided displaceably and which is divided by the piston into two pressure spaces which each have a compressed air connection, one end of the piston rod penetrating the brake cylinder housing to the outside, and a spring for realizing the parking brake function also being arranged directly in one of the two pressure spaces which is designed for carrying out service brake operations by way of a pressure increase, with the result that the service brake function and the parking brake function can be realized with only two pressure spaces and the spring.

With regard to the method for controlling a combined pneumatic cylinder of this type, the invention is distinguished by the fact that, in parking brake operations, the pressure in the first pressure space without a spring is reduced, with the result that the spring is relieved and the piston rod extends, and, in service brake operations, the piston rod extends as a result of ventilation of the second pressure space, a force counteracting the braking force of the spring by way of a minimum pressure being maintained in the first pressure space, in particular in such a way that the braking force of the spring is compensated for.

The combined cylinder according to the invention has a very compact design as a result of the “dual utilization” of one pressure space for the service brake and the parking brake, and may also be manufactured inexpensively as a result of many components, which are otherwise necessary, being omitted.

The pneumatic brake cylinder is preferably assigned a device for keeping the pressure constant during service brake operations in the first pressure space without a spring. The effect of the spring for parking brake operations may be compensated for in a simple manner in this way during the service brake operations.

According to one exemplary embodiment, the device for keeping the pressure constant is a pressure sensor, which is connected to an electronic control device designed for the purpose of actuating a valve which is assigned to the compressed air connection.

According to another variant, the device for keeping the pressure constant is, in contrast in a simple manner, a nonreturn valve with a pressure limiting function.

The method for controlling the combined cylinder may be developed in a particularly advantageous manner by the fact that, in the event of service brake operations, at least one spring-specific parameter is considered, in order to compensate for spring-specific effects which can influence the service brake operations. It is, therefore, particularly advantageous if the spring-specific parameter which is considered and is compensated for is the individual spring force which the spring exerts on the piston. This force is determined exactly and compensated for. It is precisely this measure which makes the brake cylinder according to the invention a particularly excellent replacement for very much more expensive combined cylinders having a plurality of cylinder sections which are set against one another.

It is possible, in particular, for the spring-specific parameter to be compensated for by adaptation of the minimum pressure which, in the event of service brake operations, counteracts the spring force in the first pressure space.

However, it is also contemplated for the spring-specific parameter to be compensated for by an increase in the pressure in the second pressure space having the spring, before the actual service brake pressure is built up in the second pressure space (for example, by a short corresponding air blast for pressure increase in accordance with the spring characteristic).

Furthermore, it is particularly advantageous and also desirable from a safety point of view if the spring-specific parameter is determined by an initialization process during startup of the vehicle, during maintenance, or at another defined instant.

The spring-specific parameter may, therefore easily be determined by determination of the service brake pressure which is required in order for the brake linings of a disc brake to come into contact with the brake disc, for example in the event of predefined pressure conditions in the first pressure space. Here, it is again expedient if the determination of the service brake pressure, which is required in order for the brake linings to come into contact with the brake disc, is determined by way of test braking operations at different pressures in the second and/or first pressure space.

Determining the contact between the brake linings and the brake disc may take place by means of a contact sensor on the disc and brake lining or, in particular, by means of electromechanical adjusting motors which rotate adjusting spindles for displacing the brake linings during the test braking operations, which adjusting spindles stop when the brake linings come into contact with the brake disc.

The previously mentioned variant is suitable only when the disc brake has electrically actuated adjusting spindles on one or both sides of the brake disc. The combined cylinder is a particularly advantageous and a space-saving solution precisely for this design, but not only for this design, because the “contact point” may be determined here simply by registration of a change in the motor current when bringing the linings into contact with the disc. Here, the disc is “reached” or “touched” when the brake pressure is so large, that, for example, the force of the spring against the sufficiently large counterpressure is overcome.

Other objects, advantages and novel features of the present invention will become apparent from the following detailed description of the invention when considered in conjunction with the accompanying drawings.

### BRIEF DESCRIPTION OF THE DRAWING FIGURES

FIG. 1 is a sectional view through a diagrammatic illustration of a combined pneumatic cylinder according to the invention, in which two operating positions are indicated; and

FIG. 2 shows a plan view of the cylinder from FIG. 1.

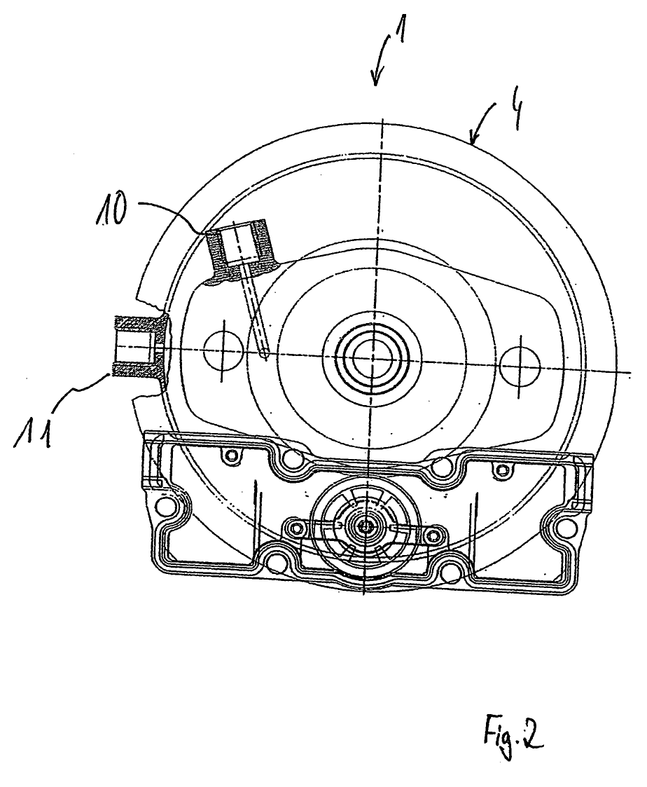

### DETAILED DESCRIPTION OF THE DRAWINGS

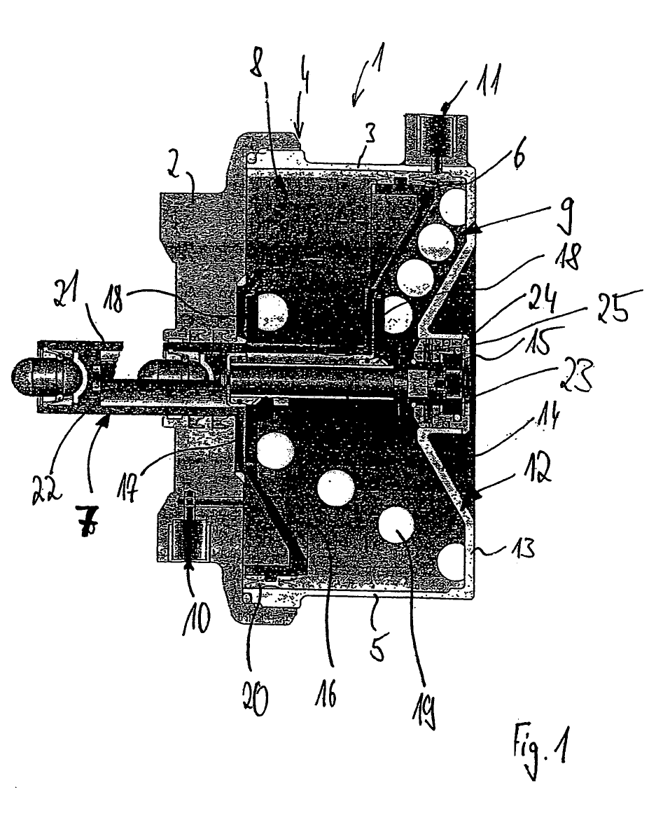

FIG. 1 shows a combined pneumatic cylinder 1, with which the service, auxiliary and parking brake function of a brake of the vehicle can be realized.

Here, the combined pneumatic cylinder 1 has a (screwed) brake cylinder housing 4, which is composed of a cover part 2 and a cup-shaped part 3 and in which a piston 6 is guided displaceably, which piston 6 is arranged on a piston rod 7 which penetrates the cover part 2 of the brake cylinder housing 4 and is designed for the purpose of actuating the associated brake, preferably a disc brake.

The piston 6 divides the interior of the brake cylinder housing 4 into a first pressure space 8 (here, shown on the left) and a second pressure space 9 (here, shown on the right), into which in each case a compressed air connection 10, 11 which penetrates the outer wall of the brake cylinder housing 4 opens.

The first cup-shaped part 3 has a cylindrical cover 5 and a basic section 12.

The basic section 12 is divided into an outer ring section 13 and a conical section 14 toward the interior of the brake cylinder housing. In the center of the conical section 14, the cover part is penetrated by a head part 15 of a release device 24, which permits a manual release of the parking brake. Here, the head part 15 may be provided, for example, with an internal polygonal shape, an external polygonal shape, or the like.

In a similar way to the basic section 12, the piston 6 is likewise divided in the region of its outer piston collar, but into an outer conical section 16 and an inner ring section 17 around the piston rod. A collar 18 is arranged on the ring section 17 on the side which faces toward the second pressure space 9 and toward the basic section 12. The diameter of the collar 18 corresponds substantially to the diameter of the ring section 17 of the piston collar. The collar 18 rests loosely on the piston 6.

A helical spring 19, a conical spring of very compact design which minimizes the second pressure space, is arranged between the collar 18 and the ring section 13 of the basic section 12. On its outer circumference, the piston collar is provided with a sealing ring 20 for sealing with respect to the inner circumference of the cylindrical cover 5.

Here, the piston rod 7 is configured as an internally hollow projection 21 of the piston 6. A threaded spindle 23 of the release device, which is stationary in the event of service brake operations and is displaceable relative to the piston 6, is situated in the hollow space 22, onto which threaded spindle 23 the collar 18 is screwed directly or via intermediate elements such as a nut 25 and/or bearings, with the result that the parking brake can be released manually in particular situations by screwing back the collar 18, without the function of the service brake being influenced by this. In this way, the collar 18 becomes a part of the release device which releases the collar and the spring from the piston, and therefore the brake, without the service brake function being impaired until maintenance which is to take place directly after the end of the journey, may still be operated

As the two pressure spaces 8, 9 are provided in each case with a compressed air connection, they can be connected to a compressed air source or the like and can, in each case, have air supplied to them or removed from them.

The functions which are mentioned above for the service brake, parking brake and auxiliary brake, may be realized with the combined pneumatic cylinder shown with an extremely compact design of the combined pneumatic cylinder if the pressure spaces 8, 9 are controlled in a suitable manner, which is described in the following.

In a manner different from combined pneumatic cylinders of a conventional design, in which the helical spring is arranged in a separate spring accumulator section or part, the helical spring is integrated here, however, directly into the actual “service brake cylinder”, or to be more precise into the pressure space 9 which is also used for activating the service brake.

The helical spring 19 serves in a customary manner for actuating the parking brake. If the helical spring 19 is released, it displaces the collar 18 and the piston 6, with the result that the piston rod 7 extends and the associated brake is applied.

An analogous situation is true in principle for the service brake system, the piston rod 7 extending in this case as a result of ventilation of the second pressure space 9.

In addition, a minimum pressure is maintained in the event of service brake operations in the first pressure space 8 on the side which faces away from the helical spring, which minimum pressure counteracts the effect of the helical spring, in order that the forces of the helical spring 9 and the forces on the piston which are caused by the ventilation of the second pressure space 9 are not added together.

The service brake and the parking brake therefore remain functional in a separate manner, although a surprisingly large amount of common components can be used for them. In contrast, the parking cylinder section of the conventional design can be omitted.

In order to keep the pressure in the first pressure space constant at the value Pmin during service brake operations, it is not sufficient to assign the associated compressed air connection a nonreturn valve. In addition, a suitable device is necessary for keeping the pressure constant via pressure sensing or a nonreturn valve with a pressure limiting function.

As the helical spring also has an effect on the characteristic of the combined pneumatic cylinder during service brake operations as a result of tolerances, it is advantageous to measure the novel combined pneumatic cylinders once during operation (or to “calibrate” them repeatedly). This can take place, for example, once during startup automatically by suitable initialization software which actuates the brakes of a vehicle or of at least one axle one after another and performs the calibration in the process.

As a result of the measurement, a characteristic value is determined for every combined pneumatic cylinder, which characteristic value corresponds to the spring force which is to be taken into consideration during a service brake operation. As the springs can differ from one another by a few percent as a result of tolerances or can have different spring forces from one another by a few percent, it is advantageous, in order to avoid different braking forces at the individual wheels, to measure this exact spring force of every spring 19 and to consider or compensate for either the counterpressure in the first pressure space 8 without a spring 19 or the service brake pressure in the second pressure space 9 accordingly during subsequent service brake operations.

The former can take place by setting a correspondingly reduced or increased counterpressure in the first pressure space 8, and the second can take place by a corresponding brief pressure increase in the second pressure space 9 before the actual service break operation is carried out.

However, it is necessary with regard to this to know the characteristic of every spring 19. This can be determined, for example, advantageously by braking operations being carried out, for example, during startup of the vehicle or after a service at different, for example increasing, pressures and it being determined in the process when the brake linings bear against the brake disc and therefore the actual braking action starts.

In order to determine the pressure, at which the brake linings come into contact with the brake disc, either sensing is possible, for example via a contact sensor on the lining and brake linings, or, for example, determination by way of electromechanically actuated adjusting apparatuses which are started in each case during the test measurements or test braking operations at different pressure and are used to set the adjusting spindle or spindles in rotation and then to determine the pressure, for example by sensing a change in the motor current at the instant of contact between the brake lining and the brake disc, which pressure is necessary in each case to overcome the spring force in otherwise predefined pressure conditions (in the first pressure space 8).

Table of Reference Numbers

| | |
|---|---|
| 1 | Combined pneumatic cylinder |
| 2 | Cover part |
| 3 | Cup-shaped part |
| 4 | Brake cylinder housing |
| 5 | Cylindrical cover |
| 6 | Piston |
| 7 | Piston rod |
| 8, 9 | Pressure spaces |
| 10, 11 | Compressed air connections |
| 12 | Basic section |
| 13 | Outer ring section |
| 14 | Conical section |
| 15 | Head part |
| 16 | Conical section |
| 17 | Inner ring section |
| 18 | Collar |
| 19 | Helical spring |
| 20 | Sealing ring |
| 21 | Projection |
| 22 | Hollow space |
| 23 | Threaded spindle |
| 24 | Release device |
| 25 | Nut |

The foregoing disclosure has been set forth merely to illustrate the invention and is not intended to be limiting. Since modifications of the disclosed embodiments incorporating the spirit and substance of the invention may occur to persons skilled in the art, the invention should be construed to include everything within the scope of the appended claims and equivalents thereof.

What is claimed is:

1. A combined pneumatic cylinder for a vehicle brake, comprising:
a brake cylinder housing;
a piston having a piston rod, the piston being guided displaceably in the brake cylinder housing, one end of the piston rod penetrating the brake cylinder housing to an exterior thereof;
wherein the brake cylinder housing is divided by the piston into two pressure spaces, each pressure space having a compressed air connection;
a spring for realizing a parking brake function of the vehicle brake, the spring being arranged directly in one of the two pressure spaces designed for performing service brake operations via a pressure increase, whereby the service brake function and the parking brake function are both realized with only two pressure spaces in the housing and the spring.

2. The combined pneumatic cylinder as claimed in claim 1, further comprising, a device, assigned to the pneumatic brake cylinder, for keeping a consistent pressure in the first pressure space without a spring during service brake operations.

3. The combined pneumatic cylinder as claimed in claim 2, wherein the device for keeping the pressure constant has a pressure sensor, which is connected to an electronic control device designed for actuating a valve which is assigned to the compressed air connection.

4. The combined pneumatic cylinder as claimed in claim 2, wherein the device for keeping the pressure constant has a nonreturn valve with a pressure limiting function.

5. The combined pneumatic cylinder as claimed in claim 1, wherein the brake cylinder housing is of at least a two-part configuration, including a cover part and a cup-shaped part.

6. The combined pneumatic cylinder as claimed in claim 5, wherein the cup-shaped part includes a basic section, which is divided into a ring section and a conical section.

7. The combined pneumatic cylinder as claimed in claim 6, wherein the piston is divided into a ring section and a conical section.

8. The combined pneumatic cylinder as claimed in claim 5, wherein the cover part is provided by a head part of a release device for manual release of the spring in an event of a parking brake operation.

9. The combined pneumatic cylinder as claimed in claim 7, further comprising a collar arranged on the ring section of the piston on a side facing toward the second pressure space or toward the conical section of the housing.

10. The combined pneumatic cylinder as claimed in claim 9, wherein the collar rests loosely on the piston.

11. The combined pneumatic cylinder as claimed in claim 9, wherein the spring is arranged between the collar and the ring section of the basic section.

12. The combined pneumatic cylinder as claimed in claim 1, wherein the spring is a helical spring.

13. The combined pneumatic cylinder as claimed in claim 12, wherein the helical spring is configured as a conical spring.

14. The combined pneumatic cylinder as claimed in claim 9, wherein the collar is configured as part of an emergency release device, and further wherein, when the emergency release device is actuated, the spring on the collar is released from the piston resulting in a release of the parking brake without the service brake function being impaired.

15. The combined pneumatic cylinder as claimed in claim 14, wherein the piston rod is configured as an internally hollow projection of the piston, in which a threaded spindle of the release device is arranged, onto which threaded spindle the collar is screwed directly or via intermediate elements.

16. A method for controlling a combined pneumatic cylinder including a brake cylinder housing divided by a piston into two pressure spaces, each pressure space having a compressed air connection, the piston having a piston rod and being guided displaceably in the brake cylinder housing, one end of the piston rod penetrating the brake cylinder housing to an exterior thereof, and a spring for realizing a parking brake function of the vehicle brake, the spring being arranged directly in one of the two pressure spaces designed for performing service brake operations via a pressure increase, wherein the service brake function and the parking brake function are both realized with only two pressure spaces in the housing and the spring, the method for controlling the combined pneumatic cylinder comprising the acts of:
in parking brake operations, reducing a pressure in the first pressure space without the spring, resulting in a relief of the spring and an extension of the piston rod; and
in service brake operations, extending the piston rod by ventilating the second pressure space, while maintaining, in the first pressure space, a force counteracting the braking force of the spring in the event of service brake operations by way of a minimum pressure, so as to compensate for the braking force of the spring.

17. A method for controlling the combined pneumatic cylinder according to claim 16, further comprising the act of considering at least one spring-specific parameter in the event of service brake operations.

18. The method as claimed in claim 17, wherein that the spring-specific parameter is an individual spring force which the spring exerts on the piston.

19. The method as claimed in claim 17, wherein the spring-specific parameter is compensated for by adaptation of the minimum pressure which, in the event of service brake operations, counteracts the spring force in the first pressure space.

20. The method as claimed in claim 17, wherein the spring-specific parameter is compensated for by an increase in the pressure in the second pressure space having the spring, before an actual service brake pressure is built up in the second pressure space.

21. The method as claimed in claim 17, wherein the spring-specific parameter is determined by an initialization process.

22. The method as claimed in claim 17, wherein the spring-specific parameter is determined by determination of a service brake pressure required in order that brake linings of a disc brake come into contact with a brake disc.

23. The method as claimed in one of claim 22, wherein:
a) the determination of the service brake pressure which is required in order that the brake linings of a disc brake come into contact with the brake disc is determined by performing test braking operations at different pressures in the second and/or first pressure space; and
b) determining contact taking place between the brake linings and the brake disc by use of a contact sensor or by use of electromechanical adjusting motors which rotate adjusting spindles during the test braking operations, which adjusting spindles stop when the brake linings come into contact with the brake disc.
